(19) United States
(12) Patent Application Publication
(10) Pub. No.: US 2023/0386274 A1
(43) Pub. Date: Nov. 30, 2023

(54) WIPER BLADE FOR VEHICLE NOTIFYING OF REPLACEMENT TIMING

(71) Applicant: DAEHAN SOLUTION CO., LTD, Incheon (KR)

(72) Inventors: Choong HO KWON, Seoul (KR); Pilkyu HAN, Incheon (KR)

(73) Assignee: DAEHAN SOLUTION CO., LTD, Incheon (KR)

(21) Appl. No.: 18/200,082

(22) Filed: May 22, 2023

(30) Foreign Application Priority Data
May 30, 2022 (KR) 10-2022-0065878

(51) Int. Cl. G07C 5/08; B60S 1/38; B60Q 5/00

(52) U.S. Cl. CPC G07C 5/0833; B60S 1/3848; G07C 5/0825; B60Q 5/005; B60S 2001/3844

(57) ABSTRACT

A wiper blade having a plurality of check holes consecutively formed to pass through portions of a blade in contact with a windshield surface, allows a driver to clearly see a non-wiping portion on the windshield surface as the portions in contact with the windshield surface are worn out and the check holes are open and easily recognize a replacement timing. Mounting a conductive rubber band or a tensile force sensor on the portions of the blade, allows to easily detect a degree of the wear of a blade and, particularly, by changing conductivity or a tensile force as the check holes are open, allows to more easily check the replacement timing. Visually or audibly notifying the driver of the replacement timing according to a detected signal related to the replacement timing, allows the driver to perform safe driving in quick response to the detected signal.

### CROSS-REFERENCE TO RELATED APPLICATION

This application claims priority to and the benefit of Korean Patent Application No. 10-2022-0065878, filed on May 30, 2022, the disclosure of which is incorporated herein by reference in its entirety.

### BACKGROUND OF THE INVENTION

### 1. Field of the Invention

The present disclosure relates to a wiper blade for a vehicle, and more specifically, to a wiper blade for a vehicle in which, by consecutively forming a plurality of check holes in portions of the blade in contact with a windshield and using the blade to be worn out, the check holes are exposed to make a non-wiping surface on a windshield surface visible so that a driver easily checks a replacement timing of the blade with eyes. In addition, a conductive rubber band or a tensile force sensor is mounted on the blade, and a replacement timing of the blade can be checked through a change in conductivity or a tensile force changed by the wear of the blade, thereby preventing damage to a windshield surface and achieving safe driving.

### 2. Discussion of Related Art

In general, as illustrated in FIGS. 1 to 3, a wiper W for a vehicle removes foreign substances stuck to a windshield surface or rainwater flowing along the windshield surface so that a driver may perform safe driving. The wiper W typically removes foreign substances, rainwater, etc. by a wiper blade B made of a soft material such as rubber and being in contact with the windshield surface, and the wiper blade loses a function of the wiper blade because the wiper blade is hardened or worn out over time. Therefore, as in Patent Document 1 to Patent Document 3 below, a replacement timing of a wiper blade is detected by various methods to enable safe driving.

(Patent Document 1) Korean Patent No. 10-2008911

The Patent Document 1 relates to a wiper replacement cycle notification system and a method of controlling the same and is directed to providing a wiper replacement cycle notification system including a motor sensor attached to a wiper motor to measure a torque, a rotating angle, and a rotating time of the wiper motor in a wiper device capable of wiping a surface of a windshield by the wiper motor driven according to a switch operation of a vehicle driver, a controller for storing data on an average life consumption of a wiper and calculating an effective life of the wiper after fetching the data on the average life consumption of the wiper corresponding to the information measured by the motor sensor, and a notification unit for notifying a driver of information on an effective life of the wiper through a vehicle instrument panel. Through the above system, it is possible to calculate a more accurate effective life of the wiper in consideration of a situation in which the wiper is worn out more quickly due to foreign substances or the like on the surface of the windshield, and by notifying the driver of the calculated effective life of the wiper, it is possible to help the driver to maintain a pleasant traveling environment even in a sudden rainy situation.

(Patent Document 2) Korean Patent No. 10-1927946

The Patent Document 2 relates to a method of predicting a life of a wiper for a vehicle, and a method of predicting a life of a wiper for a vehicle, which is configured to extract operation parameter information of a rain sensor switch, a wiper switch, and a washer liquid switch in a vehicle electronic control unit (ECU) to cumulatively count the number of times a rain sensor, a wiper, and a washer liquid operate and store the counting result, and predict lives of a wiper blade and a wiper arm system when the stored counting information reaches a set value to warn of a replacement timing, and thus may accurately predict and warn of the lives of the wiper blade and the wiper arm system so that the driver may replace the wiper at the right time to prevent damage to the wiper system, thereby reducing the incidence of traffic accidents caused by poor vision in rainy weather due to the wiper blade not functioning properly.

(Patent Document 3) Korean Patent No. 10-1895762

The Patent Document 3 relates to a wiper blade replacement timing display device including a housing including a first surface and a second surface, a sensor unit positioned on the first surface of the housing to measure the number of times the wipe of the wiper blade is performed, and a recognition unit positioned on the second surface of the housing to notify of the number of times the wipe of the wiper blade is performed, wherein by measuring the number of times the wipe of the wiper blade is performed through the sensor unit and notifying the recognition unit of the measuring result, a driver may easily determine a replacement timing of the wiper blade.

### RELATED ART DOCUMENTS

### Patent Documents

(Patent Document 1) Korean Patent No. 10-2008911 (registered date: Aug. 2, 2019)
(Patent Document 2) Korean Patent No. 10-1927946 (registered date: Dec. 5, 2018)
(Patent Document 3) Korean Patent No. 10-1895762 (registered date: Aug. 31, 2018)

### SUMMARY OF THE INVENTION

However, when a replacement timing of a wiper blade is determined by the conventional techniques, the following problems occur.

(1) There is a problem that since a service life of the wiper blade is predicted through service lives of parts constituting a wiper device and a replacement timing is notified of according to the service lives of the parts, the wiper blade that may be continuously used should also be replaced when reaching the replacement timing.

(2) This acts as one factor that increases industrial waste and increases a maintenance cost by discarding the wiper blade that may be more used.

(3) In particular, a driver who may not know whether the wiper blade may be more used by directly checking the wiper blade with eyes has the inconvenience of having to replace the wiper blade whenever the replacement timing of the wiper blade is notified of as described above.

(4) Even when the wiper blade wears out quickly due to poor manufacturing or even when the blade is not in contact with the windshield surface due to poor assembly of the wiper blade and may not properly wipe the windshield surface, this may be determined to be a normal state. This may cause damage to the windshield because a support for supporting the blade or the like is in direct contact with the windshield surface, thereby interfering with safe driving.

The present disclosure is directed to providing a wiper blade for a vehicle notifying of a replacement timing, which may have a plurality of check holes consecutively formed to pass through portions of the blade in contact with a windshield surface to allow a driver to clearly see a non-wiping portion on a windshield surface as the portions in contact with the windshield surface are worn out and the check holes are open and easily recognize a replacement timing.

In addition, the present disclosure is directed to providing a wiper blade for a vehicle notifying of a replacement timing, in which a conductive rubber band or a tensile force sensor is mounted on such a portion of the blade to easily detect a degree of the wear of the blade and, particularly, more easily check a replacement timing by more largely changing conductivity or a tensile force as the check holes are open.

In addition, the present disclosure is directed to providing a wiper blade for a vehicle notifying of a replacement timing, which is configured to visually or audibly notify a driver of a replacement timing according to a detected signal related to the replacement timing so that a driver performs safe driving in quick response to the detected signal.

According to a wiper blade for a vehicle notifying of a replacement timing, which is installed on a wiper device of the vehicle, the wiper blade includes check holes (110) consecutively formed in a longitudinal direction to pass through portions in contact with a windshield.

A conductive rubber band (120) or a tensile force sensor and a warning device may be mounted on the wiper blade, and when the wiper blade is worn out and the check holes 110 are open, the wiper blade may issue warning through the warning device based on a signal detected by the conductive rubber band 120 or the tensile force sensor.

The warning device may be at least one of a horn which allows a driver to hear a sound and a warning lamp which allows the driver to visually check.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view illustrating a vehicle equipped with a conventional wiper device;

FIG. 2 is a plan view of a vehicle illustrating a state in which a windshield surface is cleaned with the conventional wiper device mounted on the vehicle;

FIG. 3 is a perspective view illustrating the conventional wiper device;

FIG. 4 is a view illustrating a wiper blade for a vehicle notifying of a replacement timing according to the present disclosure, in which FIG. 4A is a perspective view and

FIG. 4B is a side view;

FIG. 5 is a view illustrating a state in which check holes are open in the wiper blade for a vehicle notifying of the replacement timing according to the present disclosure, in which FIG. 5A shows a wiping state and FIG. 5B is a side view illustrating the wiper blade; and

FIG. 6 is a side view illustrating an example in which a conductive rubber band or a tensile force sensor is mounted on the wiper blade for a vehicle notifying of the replacement timing according to the present disclosure.

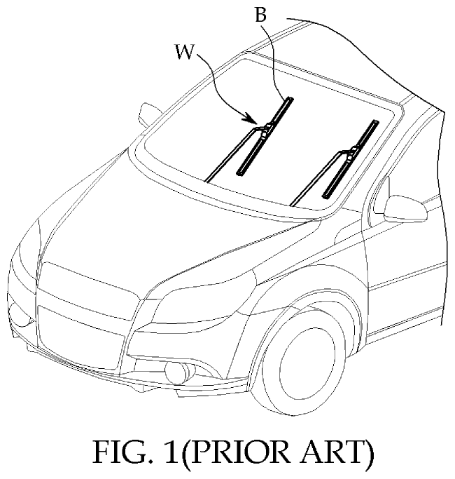

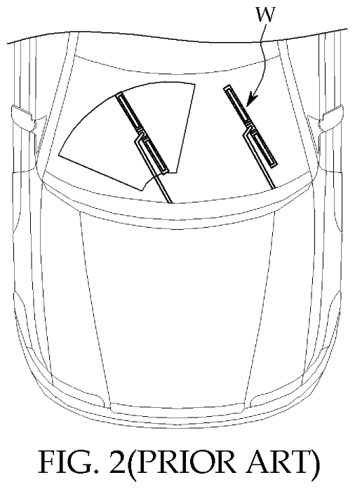

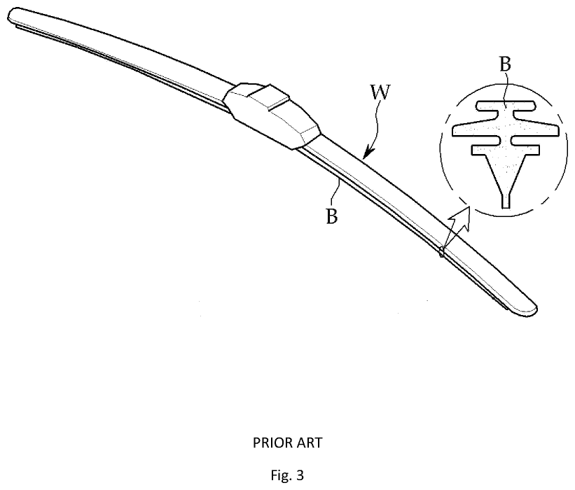

### DETAILED DESCRIPTION OF THE INVENTION

Hereinafter, exemplary embodiments according to the present disclosure will be described in detail with reference to the accompanying drawings. Prior to the description, terms or words used in the specification should not be construed as being limited to their usual or dictionary meanings and should be construed as meaning and concept consistent with the technical spirit of the present disclosure according to a principle in which the inventors can appropriately define the concept of the terms in order to describe their inventions in the best method.

Therefore, since the embodiments described in the specification and the configurations illustrated in the drawings are only the most exemplary embodiment of the present disclosure and do not represent all of the technical spirit of the present disclosure, it should be understood that various equivalents and modified examples capable of replacing the embodiments and the configurations may be present at the time of this application.

Configuration of Wiper Blade

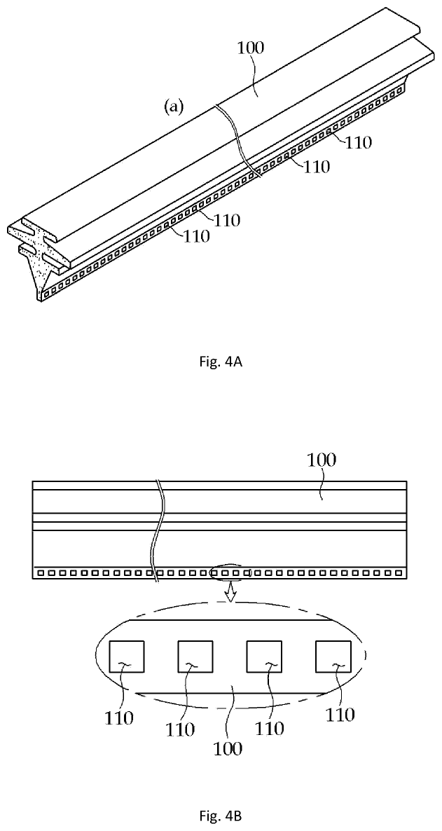

As illustrated in FIGS. 4 to 6, a wiper blade for a vehicle notifying of a replacement timing according to the present disclosure includes a blade 100 in contact with a windshield surface of a vehicle to remove rainwater, foreign substances, etc.

In particular, a plurality of check holes 110 may be consecutively formed to pass through portions of the blade 100 in contact with a windshield surface to allow a driver to visually and easily see a non-wiping portion on the windshield surface as the blade 100 is used and worn out and the check holes 110 are open and easily recognize a replacement timing of the blade 100.

In addition, the blade 100 is equipped with a conductive rubber band 120 or a tensile force sensor and configured to have a warning device operated by receiving a signal detected by the conductive rubber band 120 or the tensile force sensor to issue warning by easily detecting the replacement timing of the blade 100 through conductivity or a tensile force that varies as the check holes 110 are open.

At this time, the driver may easily recognize the replacement timing of the blade 100 even during driving using at least one of a horn which allows the driver to hear a sound and a warning lamp which allows the driver to visually check as the warning device and quickly cope with this.

Hereinafter, such a configuration will be described in more detail with reference to the accompanying drawings as follows.

A. Blade

As illustrated in FIGS. 4 to 6, the blade 100 is in direct contact with the windshield surface to remove foreign substances stuck to the windshield surface, rainwater flowing along the windshield surface, etc.

Therefore, since the blade 100 removes rainwater or foreign substances while swing in a lateral direction while in contact with the windshield surface, it is preferable to use the blade 100 made of a material such as rubber or silicone and polyurethane to prevent damage to the windshield surface even during repeated work.

Meanwhile, as illustrated in FIGS. 4 to 6, the check holes 110 are formed to pass through the blade 100 formed as described above. In addition, the blade 100 is also equipped with the conductive rubber band 120 or the tensile force sensor to notify the replacement timing through the warning device.

B. Check Holes

As illustrated in FIGS. 4 to 6, a plurality of check holes 110 are consecutively formed in a longitudinal direction to pass through portions of the blade 100 in contact with the windshield surface of the vehicle.

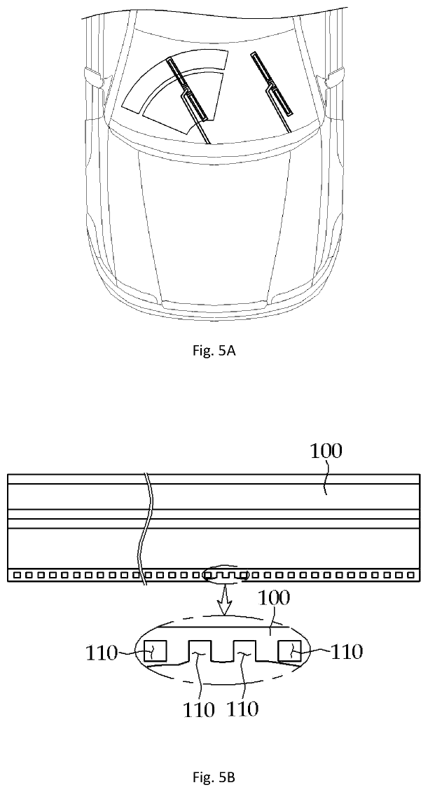

This is for a driver to immediately recognize the replacement timing of the blade 100 and cope with this by allowing the driver to easily see a non-wiping portion on the windshield surface, which is generated because open portions are not in contact with the windshield surface as the check holes 110 are open due to the wear of the blade 100 part in contact with the windshield surface with the use of the blade 100 as illustrated in FIG. 5.

Therefore, in an exemplary embodiment of the present disclosure, as illustrated in FIGS. 4 to 6, by forming two adjacent holes to maintain the same interval when formed to pass through portions of the blade 100 in contact with the windshield surface, when the check holes 110 are open due to the wear of the blade 100 or foreign substances or the like stuck to the windshield surface, the open portions are not in contact with the windshield surface and thus the windshield surface is not clearly wiped, thereby making it easy to recognize a damaged range of the blade 100. This may make it easy to recognize the replacement timing because a non-wiping portion on the windshield surface is as wide as the check holes 110 are open even when the worn portions of the blade 100 are small.

As described above, as illustrated in FIGS. 4 to 6, the blade 100 formed with the check holes 110 is equipped with the conductive rubber band 120 or the tensile force sensor to notify the driver of the replacement timing of the blade through the warning device.

C. Conductive Rubber Band or Tensile Force Sensor

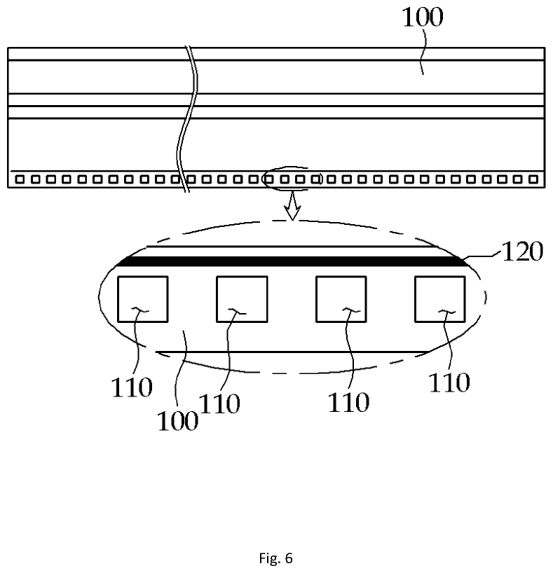

The conductive rubber band 120 or the tensile force sensor is mounted on the blade 100 as illustrated in FIG. 6.

Here, the conductive rubber band 120 is manufactured in the form of a rubber band, is manufactured by a typical technique in which conductivity varies depending on a change in length, and accurately notifies of the replacement timing of the blade by measuring conductivity that varies as the blade 100 is used and the portions in contact with the windshield surface are worn out. At this time, since the conductivity greatly varies depending on whether the check holes 110 are open and the number of open check holes 110, it is possible to more accurately detect the replacement timing. In addition, the tensile force sensor is mounted on the blade 100 to detect a tensile force that varies in proportion to a degree of expansion or contraction of the blade 100 due to the wear of the blade 100, and thus the replacement timing can be recognized.

The detected signal allows the driver to recognize the replacement timing of the blade through the warning device.

D. Warning Device

Although not illustrated in the drawings, the warning device is mounted at a position at which the driver may see or hear the detected signal even during driving. In this case, it is preferable that the warning device be configured so that the driver recognizes the replacement timing of the blade through the warning device even during driving using at least one of the horn which allows the driver to hear a sound and the warning lamp which allows the driver to visually check and immediately copes with this.

As described above, according to the present disclosure, by allowing the driver to recognize the replacement timing of the blade as the check holes formed to pass through the blade are open, it is possible to replace the blade in a state in which the blade may not be actually used regardless of the number of times or period of use without unnecessarily replacing the blade. In addition, by allowing the driver to easily recognize the replacement timing through the conductive rubber band or the tensile force sensor and the warning device, it is possible to quickly and accurately notify the driver of the replacement timing of the blade.

A wiper blade for a vehicle notifying of a replacement timing according to the present disclosure has the following effects.

(1) By having a plurality of check holes formed in a longitudinal direction to pass through portions of the blade in contact with a windshield surface, a driver can easily check a non-wiping portion on the windshield surface as the portions of the blade are worn out and the check holes are open and easily recognize a replacement timing.

(2) Therefore, it is possible to easily check whether the portions of the blade are worn out by wiping the windshield surface according to an operation of a wiper device during driving and replace the wiper blade, thereby helping in safe driving.

(3) Meanwhile, by mounting a conductive rubber band or a tensile force sensor on a blade, it is possible to quickly and accurately detect a replacement timing of the blade through conductivity and a tensile force that varies as the check holes are open and notify the driver of the detecting result.

(4) Since the notification at this time is made using at least one of a warning lamp which allows the driver to visually check and a horn which allows the driver to hear a sound, the driver can easily and conveniently recognize the replacement timing of the blade even during driving and cope with this.

What is claimed is:

1. A wiper blade for a vehicle notifying of a replacement timing, which is installed on a wiper device of the vehicle, the wiper blade comprising check holes consecutively formed in a longitudinal direction to pass through portions in contact with a windshield.

2. The wiper blade of claim 1, wherein a conductive rubber band or a tensile force sensor and a warning device are mounted on the wiper blade, and
when the wiper blade is worn out and the check holes are open, the wiper blade issues warning through the warning device based on a signal detected by the conductive rubber band or the tensile force sensor.

3. The wiper blade of claim 2, wherein the warning device is at least one of a horn which allows a driver to hear a sound and a warning lamp which allows the driver to visually check.
